(19) United States
(12) Patent Application Publication
(10) Pub. No.: US 2014/0358608 A1
(43) Pub. Date: Dec. 4, 2014

(54) AUTOMATIC PRIORITIZATION OF INCIDENT RESPONSE AS A HISTORICAL FUNCTION OF CUSTOMER STATE

(71) Applicant: International Business Machines Corporation, Armonk, NY (US)

(72) Inventors: Silvia Cristina Sardela Bianchi, Sao Paulo (BR); Victor Fernandes Cavalcante, Sao Paulo (BR); Rogerio Abreu de Paula, Sao Paulo (BR)

(21) Appl. No.: 13/904,926

(22) Filed: May 29, 2013

(51) Int. Cl. G06Q 10/06; G06Q 30/00

(52) U.S. Cl. CPC G06Q 10/063114; G06Q 30/016
USPC 705/7.15

(57) ABSTRACT

A method (and structure) for prioritization of incident reports includes receiving an incident report from one of a plurality of clients. For each client incident report, information is retrieved from a database concerning a business relevance of a client relationship with the client at a time period for resolving the received incident report. A prioritization of the received incident report is calculated, as executed by a processor on a computer, the prioritization including a parameter that quantifies a customer state. An incident report ticket is generated that includes aggregated key information of the received incident report and that includes an indication of the calculated prioritization. The incident report ticket is provided as an output intended for a problem resolver to address the received incident report.

### BACKGROUND OF THE INVENTION

1. Field of the Invention

The present invention generally addresses prioritizing tickets generated from incident reports that require service by a problem resolver. More specifically, tickets are prioritized in consideration of a parameter for customer relationship state at the time of the incident report, so that problem resolution tickets are prioritized taking into account at least this additional parameter for customer/business state.

2. Description of the Related Art

FIG. 1 shows a conventional mechanism 100 for automatic assignment of priorities of incoming incident reports, as related to such activities as call centers or other entities for which problem resolvers are required to address and resolve problems related to providing service to various clients. More generally, the present invention is directed to any organization or entity that provides problem resolution services to a plurality of clients.

As shown in FIG. 1, various clients provide incident reports into a FIFO (first in first out) queue 101, which get dispatched 102 to system administers 103 for resolution. In some conventional systems an incident service management tool 104 generates the incident reports, possibly making adjustments to the priorities of the input reports.

In the conventional methods, time-bounded incident-resolution activities are usually handled considering target resolution times determined by contractual statement agreements. Incoming incidents, whether human reported (e.g., server access denial) or machine generated (e.g., disk space monitoring) are represented by tickets. Tickets are thus the smallest unit of information that aggregates all key information for those individual incidents. In the context of (time-bounded) incident management, ticket prioritization is conventionally based solely on its severity and/or upper-bound resolution time. The resolution time is in turn determined by the service level agreements (SLAs) stated in service delivery contracts.

The use of such a simple prioritization strategy is typically justified by the lack of appropriate human and technological resources to handle it, namely, (a) the (large) number of incoming tickets that need to be handled within a short time-frame by small-size support teams, and (b) being a manual, overlapping task (i.e., people having to concurrently carry out ticket analysis/dispatching and incident resolution activities).

However, this strategy is not efficient and is unable to optimize for a more complex set of criteria. For instance, it is not capable of addressing critical business needs and considerations of both service providers and, more important, their clients (or customers: it is noted that, hereinafter, the terms “client” and “customer” are used more or less interchangeably).

Particularly, in the context of service delivery, several important decision criteria used by service providers go beyond contractual constraints, such as the status of the business relationship between a service provider and its clients' business needs, client satisfaction, and the like. More elaborate approaches that take into account more complex sets of criteria are paramount to improving the quality as well as the efficiency and efficacy of incident-resolution services.

For example, in one conventional mechanism, Bayesian techniques are used to prioritize network alerts. In another approach, a conventional work proposal system and method for incident prioritization in IT services is based on the probability of the service level violation or on the cost of solving the incident. Another conventional mechanism provides systems and techniques that receive a plurality of reviews and score them based on some predefined criteria, e.g., feedback from other users.

However, the present inventors have recognized that conventional approaches for prioritizing and assigning tickets to problem resolvers that rely only on such factors as time, cost, and/or contractual constraints can be, and should be, improved because they fail to take into account at least one other important factor.

### SUMMARY OF THE INVENTION

In view of the foregoing, and other, exemplary problems, drawbacks, and disadvantages of the conventional systems, it is an exemplary feature of the present invention to provide a structure (and method) in which at least one factor additional to conventional parameters such as time, cost, and/or contractual constraints is considered in assigning priorities for tickets to be assigned to problem resolvers.

It is another exemplary feature of the present invention to incorporate a new parameter described herein as “customer state”, which quantifies a business relevance of a customer/client relationship at a particular time into the determination of priorities of problem resolution tickets.

It is another exemplary feature of the present invention to optimize incident assignment and resolution using not only time, cost, and/or contractual constraints but also business components and historical knowledge of past incident resolution performances.

Therefore, in a first exemplary aspect of the present invention, to achieve the above features and objects, described herein is a method including receiving an incident report from one of a plurality of clients; for each client incident report, retrieving information from a database concerning a business relevance of a client relationship with the client at a time period for resolving the received incident report; calculating, as executed by a processor on a computer, a prioritization of the received incident report, the prioritization including a parameter that quantifies a customer state; generating an incident report ticket that includes aggregated key information of the received incident report and that includes an indication of the calculated prioritization; and providing the incident report ticket as an output intended for a problem resolver to address the received incident report.

In a second exemplary aspect, also described herein is an apparatus that selectively executes instructions of this method of prioritization of client incident reports.

In a third exemplary aspect, also described herein is a non-transitory storage memory device that has tangibly embedded therein the set of instructions that implement this method of prioritization of client incident reports.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 shows a conventional ticket dispatching system 100;

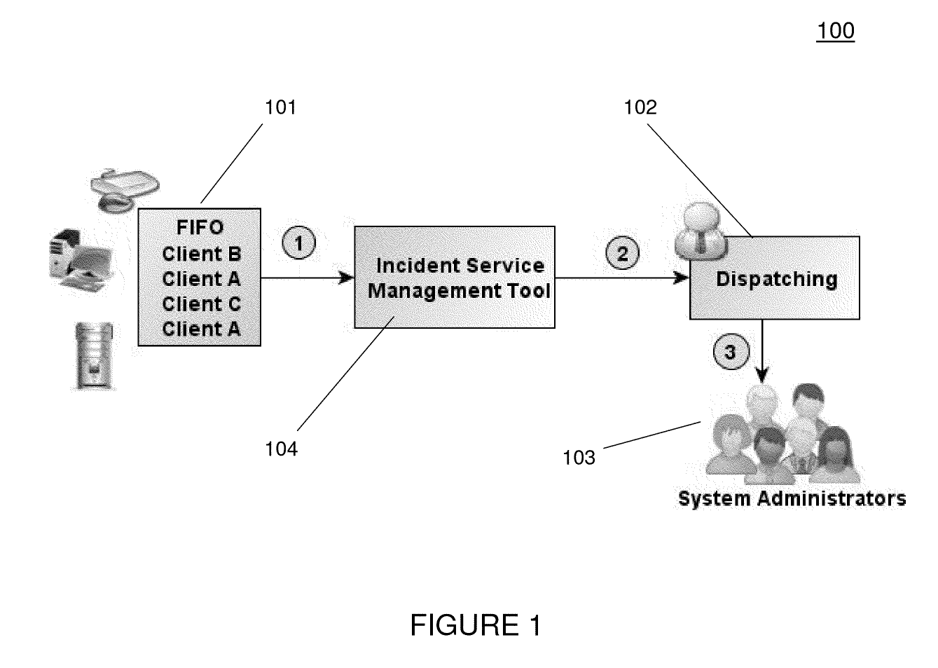

FIG. 2 shows an exemplary embodiment of a ticket prioritization system 200 of the present invention;

FIG. 3 shows exemplary historical data 300 used for an example that demonstrates the present invention;

FIG. 4 illustrates an exemplary hardware/information handling system 400 for incorporating the present invention therein; and

FIG. 5 illustrates a non-transitory, signal-bearing storage medium 500 (e.g., storage medium) for storing steps of a program of a method according to the present invention.

### DETAILED DESCRIPTION OF AN EXEMPLARY EMBODIMENT OF THE INVENTION

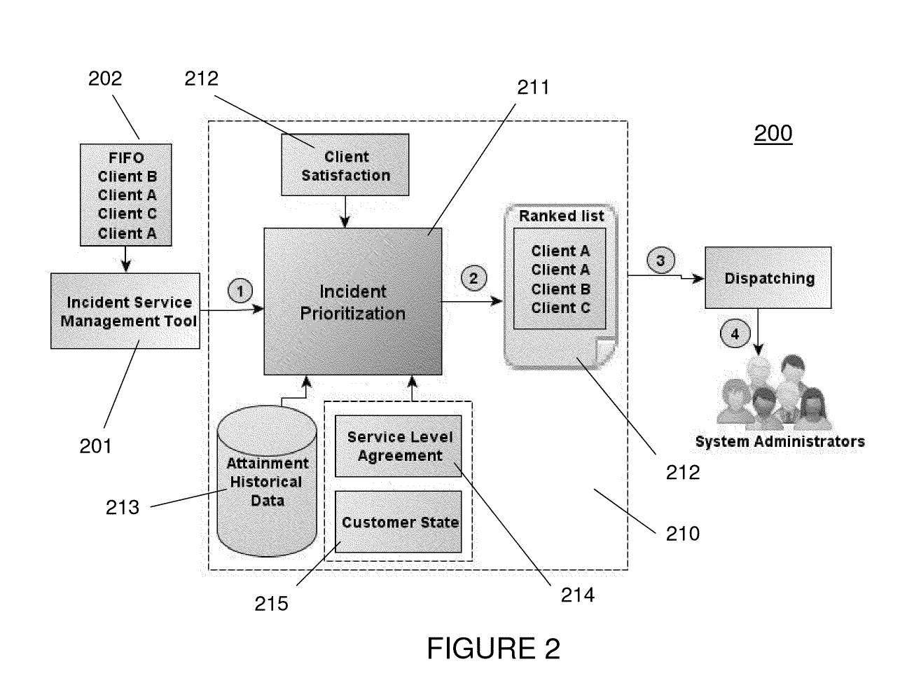

Referring now to the drawings, and more particularly to FIGS. 2-5, exemplary embodiments of the method and structures according to the present will now be described.

FIG. 2 exemplarily shows a system 200 incorporating concepts of the present invention. In general, tickets are ordered in the Incident Service Management Tool 201 as they arrive, in a first-come, first-served fashion (i.e., FIFO—first in first out) 202. Because a large amount of information is usually collected and reported, the present inventors have recognized that it is important to prioritize the incidents to be handled not only to meet a customer's service level agreement (e.g., contractual prerogatives) but even more important to meet business goals and needs.

Accordingly, the present invention provides a ticket prioritization strategy that, in addition to a response time upper-bound, considers business relevant criteria, such as business/customer state of a client relationship at a particular time, as well as client satisfaction, and historical data of previous incident handling outcomes. In doing so, the present invention optimizes incident assignment and resolution using not only time constraints but also business components and historical knowledge of past incident resolution performances, which is recognized by the present inventors as being absent in conventional approaches for prioritizing and assigning tickets to problem resolvers.

The benefits of this invention include, but are not limited to:

1. It provides a ranked list of the incidents in order to prioritize the ticket resolution that is more aligned with a service provider business' needs as well as its clients' rather than solely determined by time and cost metrics.

2. It provides an automated, business oriented incident assignment and resolution process optimization that better prioritizes incident response time for high-priority business clients.

3. It provides an indirect mechanism for improving client satisfaction by focusing on clients' needs, while at the same time achieving clear business goals.

As shown in FIG. 2, incident resolution requests (tickets) generated by monitoring tools or reported by the clients arrive and are placed in a queue (1) that could be part of the Incident Management Tool 201.

Next, a prioritization technique of the present invention is applied 211 and the incidents are sorted according to business priorities (2). Exemplary criteria considered in the prioritization method include quantitative values for: client satisfaction 212, attainment historical data 213, service level agreement 214, and customer state 215.

The ranked list of tickets (3) is then handed over to the dispatching system that automatically assigns tickets to system administrators (4) who can now handle the incidents of higher business and client priorities.

The prioritization method may be described as follows. For an incoming, unsorted ticket list [t₁,t₂, . . . tₙ] to be assigned, a prioritization list (ranked list)/tc, Pi is generated based on individual tickets ranked according to prioritization value PV(c(t)), where PV(c(t)) embodies the prioritization method herein described. In an exemplary embodiment, that PV(c(t)) value may be exemplarily expressed as a weighted combination of the following criteria:

1) Business/Customer State B_{c(t)}: Several examples of mechanisms that can be used to quantify the parameter of customer/business state B (labeled 215 in FIG. 2) are described herein, but these examples are not to be considered as exhaustive.

As one example of the customer state parameter, the proximity of a client's contract renewal or expansion period will increase the business-relevance/priority-curve/value. The client's state may also be quantified by referring to the metrics of the business relationship (e.g. the actual revenue of the client, the size (in currency) of the signed contract, and other such indicators that might serve to quantify relative sizes of client business).

Another example of customer/business state would be the identification of specific holidays having specific business relevance to clients at the specific time of receiving the incident report. For example, at the specific period of an incident report, some clients' business activity may be particularly dependent upon recognizing that the client is currently engaged in fulfilling consumer orders for Christmas holiday shopping or other national or local holidays having particular significance to a client's business.

This factor of business or customer state, in general, refers to any quantitative value representing a factor relative to the state of the relationship between a business and its customers at a particular time that a ticket prioritization determination is being calculated.

The present inventors consider this parameter of customer state to be a newly introduced parameter into the calculation of prioritization of tickets for client incident reports. Moreover, it should be clear to one of ordinary skill in the art that this parameter can be dependent upon any number of factors, such as exemplarily described above, and that a database could be easily developed for the specific client base being serviced by the problem resolvers, once this concept of client state is recognized.

2) Client Satisfaction S_{c(t)}:

In one exemplary mechanism, the present invention calculates and includes in the prioritization calculation a client's satisfaction (labeled 212 in FIG. 2), as based on quantifying inputs such as the number of recent complaints (by a number of different means, such as emails, phone calls, web-based systems, and the like) or sentiment analysis (also referred to as “opinion mining”). The assessment of client satisfaction may be expressed as a function that outcomes the state of a client's satisfaction level related to the service being provided. This metric could be also measured by the number of incidents reported by the client, and calculations of this metric could be stored in a database for use in determining ticket prioritization upon receipt of client incident reports.

3) Attainment Historical Data H_{c(t)}:

This parameter refers to a recent attainment (support activities) record (labeled 213 in FIG. 2) that maintains, for every client, the number of tickets and their associated urgencies (severity). This criterion can be considered as measuring how much attention a client received from the service provider recently. It is also a time dependent function.

This parameter can also be used to identify the size of the backlog of the unresolved tickets for a specific client. Taking into consideration both the client satisfaction and historical data (backlog) is critical to achieve a balance and avoid prioritizing a particular set of clients, and thereby creating undesirable biases.

The rationale here is that:

(a) Historical information about client attainments may be used to assess the level of attention each client is receiving from the provider, in order to improve or keep the fairness in terms of client attainment at each period of time. Keeping certain subsets of customers very satisfied at the same time that others remain extremely disappointed may be quite dangerous to new business development; and

(b) Another “thermometer” for deciding to increase/decrease the support to a given client is that of being aware about how satisfied a client is with the support received by the service provider.

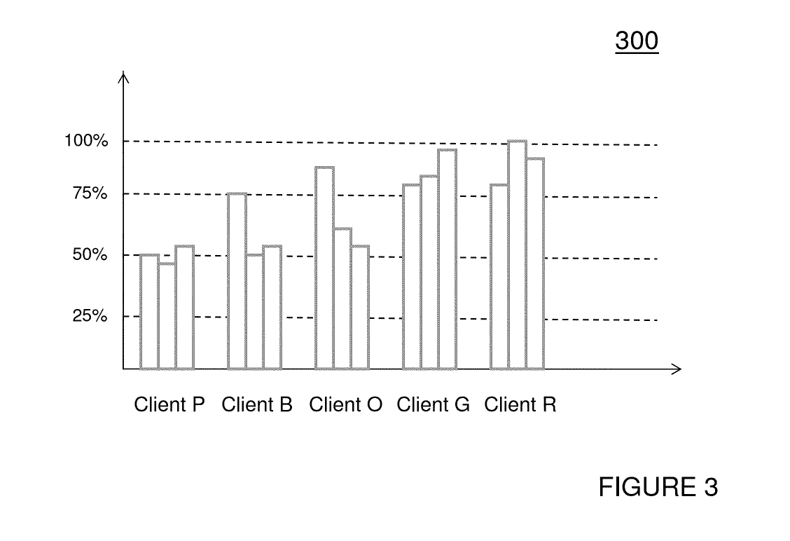

FIG. 3 presents an example 300 of exemplary data for the historical data for attainment for five clients, for which attainment data of three of which clients P, B, O, will be used in examples below that demonstrate an embodiment of the invention.

4) Service Level Agreement L_{c(t)}:

Typically, very client has negotiated a contract and a service level agreement (SLA) parameter (labeled 214 in FIG. 2), commonly verified in the art on a monthly basis. A typical SLA metric can be the percentage of tickets that should be solved in time for a certain period of time. Such data can be stored in a database for use in determining prioritization of incident report tickets.

5. Weighting of Clients W_{c(t)}:

Finally, a ranking (classification) of importance of each client, as an external metric, may also be added to the expression to distinguish the current relevance of each account (client) for the current (and/or future) portfolio or the service provider. Thus, to represent such importance, a weight, denoted W_{c(t)}, may be used.

Furthermore, assuming that B_{c(t)}, S_{c(t)}, H_{c(t)}, and L_{c(t)} are normalized (i.e., comparable) values, the weights y_{B}, y_{S}, y_{H}, and y_{L} can be used to, respectively, define the importance of each criterion in the expression. These weights can then be adjusted and improved over time, to provide a means for a feedback mechanism for dynamic adaptation.

That is, normalization is important in the present invention to make possible the comparison between different dimensions, to use the same scale of values, for example, percentage, in order to compare distinct amount and unity. Thus, normalization in the context of the present invention is relative to each parameter, keeping the same scale/range of possible values for that parameter. One or more weights may then be used to add importance to the different parcels/factors and/or to factors that are being multiplied together (as in the exemplary prioritization function described below). As the maturity level in the business changes, more knowledge about better tunings of parameters can be incorporated as the feedback mechanism mentioned above, in order to provide continuous improvement as reflected by adjustments to these weight values.

Putting together these concepts discussed above, an exemplary function to calculate prioritization value (PV) for a ticket in accordance with the present invention might be:

PV(c(t))=W_{c(t)}×[y_{B}×B_{c(t)}+y_{S}×(1−S_{c(t)})+y_{H}×(1−H_{c(t)})]+y_{L}×L_{c(t)}

where c(t) refers to the client (potentially) affected by the ticket t. The functions W, B, S and L can be initially configured by a system administrator and refined over time, including the process of using default values for a new customer whose data is not yet known.

Thus, as shown in FIG. 2, the present invention provides a computerized tool 210 that calculates incident prioritization 211 of input incident reports to provide a ranked list 212 of the calculated prioritization. The incident prioritization calculation 211 is based on a number of parameters, including quantitative values for client satisfaction 212, historical attainment data 213, service level agreement 214, and customer state 215. The present inventors believe that the prioritization calculation described herein is new in the art because of its new combination of prioritization parameters, including at least one new parameter not previously used.

### First Example

As a first example illustrating the concepts of the present invention, suppose that there are three clients (P,B,O) and a list of tickets [Tp, Tb, To] associated to these clients. As aforementioned, these tickets are listed to be treated in the order that they arrive in the incident service management tool.

In this first example the metrics of the criteria considered in the prioritization methods are:

Business/customer state: in this first example, the clients' revenues are considered as the indication of the customer state of each client.

Client satisfaction: the average number of complaints from the clients per day.

Attainment historical data: as shown in FIG. 3, in the last 3 days, the ticket resolution rate was near to 50%, 60% and 70%, respectively, for clients P, B and 0 (as an average).

Service level agreement (SLA): the percentage of the tickets that should be solved per day under the established time limit. In this example, the historical data and SLA are correlated.

Assume the following characteristics for each of these clients:

### Client P

Business/customer state: 500,000 (normalized value=0.5)

Client satisfaction: 50 (normalized value=0.5)

Attainment historical data: the average ticket resolution rate was near to 50% (normalized value=0.5)

Service level agreement: 80% (normalized value=0.8)

### Client B

Business/customer state: 1,000,000 (normalized value=1.0)

Client satisfaction: 100 (normalized value=1.0)

Attainment historical data: the average ticket resolution rate was near to 60% (normalized value=0.6)

Service level agreement: 99% (normalized value=0.99)

### Client O

Business/customer state: 250,000 (normalized value=0.25)

Client satisfaction: 20 (normalized value=0.2)

Attainment historical data: the average ticket resolution rate was near to 70% (normlized value=0.7)

Service level agreement: 90% (normlized value=0.9)

Applying the prioritization method the resulting prioritization order is:

Client B(PV(B)=2.39)>Client P(PV(P)=2.3)>Client 0(PV(0)=2.25).

Thus, supposing that an incoming ticket list [Tp, Tb, To] is resorted to a ranked ticket list based on this prioritization method, the current resulting ticket list ranked is [Tb, Tp, To] and, accordingly, the next ticket to be assigned and addressed is Tb (a ticket associated to client B).

In this first example, we considered, for simplicity, that the weights

y_{B}=y_{S}=y_{H}=y_{L}=1 =W_{c(t)} (for c(t)=B, P and 0).

### Second Example

In a second example, the business/customer state B_{c(t)} is associated with the customer c(t) having a major event, such as Easter, black Friday, or, for retailers, Christmas.

Client satisfaction Sc(t) is the number of complaints or sentiment analysis.

Attainment Historical data H_{c(t)} is the number of tickets and their associated urgencies (severity).

Service level agreement L_{c(t)} is the percentage of tickets that should be timely solved for a certain period of time.

In this second example, there are again three clients (P,B,O) and a list of tickets [Tp, Tb, To] associated to these clients, as follows:

### Client P

Business/customer state: client is a wrap factory and it is Easter period (normalized value=0.5)

Client satisfaction: 50 (normalized value=0.5)

Attainment Historical data: the average ticket resolution rate was near 50% (normalized value=0.5)

Service level agreement: 80% (normalized value=0.8)

### Client B

Business/customer state: client is a chocolate factory and it is Easter period (normalized value=1.0)

Client satisfaction: 100 (normalized value=1.0)

Attainment Historical data: the average ticket resolution rate was near to 60% (normalized value=0.6)

Service level agreement; 99% (normalized value=0.99)

### Client O

Business/customer state: client is a steel making company and it is Easter period (normalized value=0.25)

Client satisfaction: 20 (normalized value=0.2)

Attainment Historical data: the average ticket resolution rate was near to 70% (normalized value=0.7)

Service level agreement: 90% (normalized value=0.9)

Applying the exemplary prioritization equation above, the resulting prioritization order for Example 2 is:

Client B(PV(B)=2.39)>Client P(PV(P)=2.3)>Client O(PV(O)=2.25)

The prioritized list of tickets for Example 2 is: [Tb, Tp, To].

Although the above two examples and the above specific prioritization function PV should be adequate for explanation of the present invention, it should be clear that these examples and exemplary prioritization function are exemplary only and not intended as limiting the more general concepts described herein.

### Exemplary Hardware Implementation

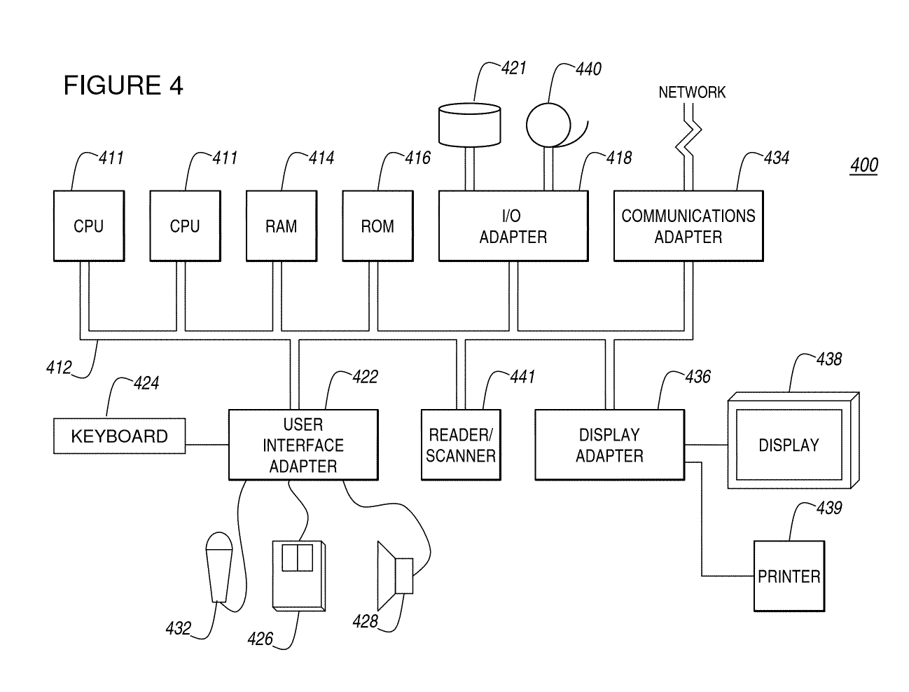

FIG. 4 illustrates a typical hardware configuration of an information handling/computer system in accordance with the invention and which preferably has at least one processor or central processing unit (CPU) 411.

The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting the information handling system to a data processing network, the Internet, an Intranet, a personal area network (PAN), etc., and a display adapter 436 for connecting the bus 412 to a display device 438 and/or printer 439 (e.g., a digital printer or the like). Additional devices such as one or more receive/transmit units (R/Ts) might also be present, particularly if the system is a portable device such as a smartphone or other similar processor-based portable device.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising a non-transitory, signal-bearing storage media tangibly embodying a program of machine-readable instructions executable by a digital data processor incorporating the CPU 411 and hardware above, to perform the method of the invention. The term “signal-bearing” is intended as implying a functionality permitting these instructions to be readable by a device on a machine.

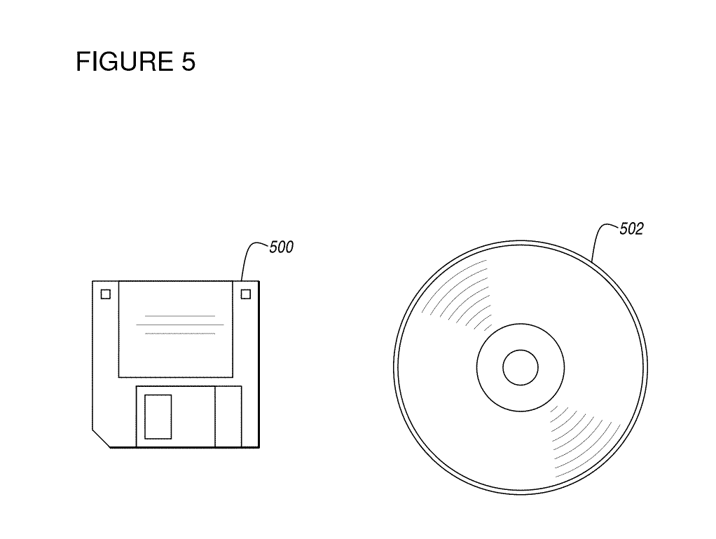

This storage media may include, for example, a RAM contained within the CPU 411, as represented by the fast-access storage for example. Alternatively, the instructions may be contained in another signal-bearing media, such as a magnetic data storage diskette 500 (FIG. 5), directly or indirectly accessible by the CPU 411.

Whether contained in the diskette 500, the computer/CPU 411, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

It is further envisioned that the present invention could be embodied in a format of an application program (e.g., an app) that is downloaded from a network server onto a user computer or user portable device having computer-like capabilities.

It is further envisioned that the present invention is directed to a method of business that is based upon using the prioritization method described herein. Thus, the present invention is directed to a business entity that receives and itself resolves these received client problem reports as a business function. Similarly, the present invention would also be directed to a business entity that receives such client problem reports but that provides such problem report tickets to another business that has the function of actually resolving these client problem reports. Along this line, it is noted that the present invention is likewise directed to a business entity having a function to resolve problem report tickets having been prioritized in the manner herein described.

While the invention has been described in terms of a single preferred embodiment, those skilled in the art will recognize that the invention can be practiced with modification within the spirit and scope of the appended claims.

Further, it is noted that, Applicants' intent is to encompass equivalents of all claim elements, even if amended later during prosecution.

Having thus described our invention, what we claim as new and desire to secure by Letters Patent is as follows:

1. A method, comprising:
receiving an incident report from one of a plurality of clients;
for each said client incident report, retrieving information from a database concerning a business relevance of a client relationship with said client at a time period for resolving said received incident report;
calculating, as executed by a processor on a computer, a prioritization of said received incident report, said prioritization including a parameter that quantifies a customer state;
generating an incident report ticket that includes aggregated key information of said received incident report and that includes an indication of said calculated prioritization; and
providing said incident report ticket as an output intended for a problem resolver to address said received incident report.

2. The method of claim 1, wherein said calculating said prioritization comprises calculating a value for a prioritization value function having a plurality of parameters included therein, including said parameter for customer state.

3. The method of claim 2, wherein said prioritization value function provides a weight factor for at least one of said parameters.

4. The method of claim 3, wherein said weight factor thereby provides a feedback mechanism that can be adjusted over time.

5. The method of claim 2, said plurality of parameters including one or more of client satisfaction, historical attainment, and service level agreement factors.

6. The method of claim 2, wherein values of said plurality of parameters are expressed in a normalized form.

7. The method of claim 6, wherein a prioritization function used for said calculating prioritization comprises an expression of a summation of parameter values of said plurality of parameters.

8. The method of claim 7, wherein one or more of said parameter values is multiplied by a weight factor in said summation expression.

9. The method of claim 7, wherein a plurality of parameter values in said summation expression have a commonly-applied weight factor.

10. The method of claim 1, as embodied by a set of computer-readable instructions tangibly embodied in a non-transitory memory device.

11. The method of claim 1, as implemented in receiving said incident report ticket prepared with said prioritization using said calculating.

12. An apparatus, comprising:
a processor; and
a memory device, wherein said memory device has stored therein a set of instructions for execution by said processor for causing said processor to:
receive an incident report from one of a plurality of clients;
for each said client incident report, retrieve information from a database concerning a business relevance of a client relationship with said client at a time period for resolving said received incident report;
calculate a prioritization of said received incident report, said prioritization including a parameter that quantifies a customer state;
generate an incident report ticket that includes aggregated key information of said received incident report and that includes an indication of said calculated prioritization; and
provide said incident report ticket as an output intended for a problem resolver to address said received incident report.

13. The apparatus of claim 12, wherein prioritization is calculated by determining a value for ticket t for prioritization value function PV(c(t)):
PV(c(t))=W_{c(t)}×[y_{B}×B_{c(t)}+y_{S}×(1−S_{c(t)})+y_{H}×(1−H_{c(t)})]+y_{L}×L_{c(t)}
where c(t) refers to said client affected by the ticket t,
W_{c(t)}, y_{B}, y_{S}, y_{H}, and y_{L} comprise weight values,
B_{c(t)} comprises a parameter representing a business/customer state of said client at a time of receiving said incident report,
S_{c(t)} comprises a parameter representing satisfaction of said client,
H_{c(t)} comprises a parameter representing a recent attainment in support activities for said client, and
L_{c(t)} comprises a parameter representing a service level agreement.

14. The apparatus of claim 13, further comprising a user interface, such that a user can provide modification values to said weights, thereby providing a potential feedback mechanism that is dynamically variable over time.

15. The apparatus of claim 13, wherein said parameters B_{c(t)}, S_{c(t)}, H_{c(t)}, and L_{c(t)} comprise parameter values that are respectively normalized within each said parameter.

16. The apparatus of claim 12, as comprising a device operated by a business entity having a function to receive and to resolve said received client reports.

17. A non-transitory, computer-readable storage medium tangibly embodying a program of machine-readable instructions executable by a digital processing apparatus to perform a method of prioritization of client incident reports, said method comprising:
receiving an incident report from one of a plurality of clients;
for each said client incident report, retrieving information from a database concerning a business relevance of a client relationship with said client at a time period for resolving said received incident report;
calculating, as executed by a processor on a computer, a prioritization of said received incident report, said prioritization including a parameter that quantifies a customer state;
generating an incident report ticket that includes aggregated key information of said received incident report and that includes an indication of said calculated prioritization; and
providing said incident report ticket as an output intended for a problem resolver to address said received incident report.

18. The storage medium of claim 17, as comprising one of:
a read only memory (ROM) device on a device having a processor capable of executing said set of instructions as an executable program;
a random access memory (RAM) device on a device having a processor currently executing said set of instructions;
a standalone memory device capable of interacting with a device having a processor capable of executing said set of instructions; and
a memory device on a server on a network capable of downloading said set of instructions to another computer on said network.

19. The storage medium of claim 18, as comprising a memory device on a computer of a business entity that provides a resolution to client incident reports.

20. The storage medium of claim 18, as comprising a memory device on a computer of a first business entity that provides information to a second business entity that provides a resolution to client incident reports.
